(19) United States
(12) Patent Application Publication
(10) Pub. No.: US 2026/0079302 A1
(43) Pub. Date: Mar. 19, 2026

(54) PROCESS FOR FABRICATING A PHOTONIC DEVICE WITH REDUCED LOSSES

(71) Applicant: COMMISSARIAT À L'ENERGIE ATOMIQUE ET AUX ENERGIES ALTERNATIVES, Paris (FR)

(72) Inventors: Pierre CHAUSSE, GRENOBLE (FR); Quentin WILMART, GRENOBLE (FR); Ségolène OLIVIER, GRENOBLE (FR)

(21) Appl. No.: 19/318,164

(22) Filed: Sep. 3, 2025

(30) Foreign Application Priority Data
Sep. 13, 2024 (FR) 2409785

(51) Int. Cl. G02B 6/136; G02B 6/12

(52) U.S. Cl. CPC G02B 6/136; G02B 2006/12038

(57) ABSTRACT

A process for fabricating a photonic device, includes the following steps:

(i) providing an optical guide structure arranged on a first thermal SiO₂ layer; the first layer being arranged on a first face of a substrate made of a semiconductor material; (ii) etching the second face, opposite the first face, of the substrate below at least part of the optical guide structure to the first thermal SiO₂ layer so as to obtain a membrane formed by part of the first layer that is suspended above a cavity delimited by two pillars; the optical guide structure being arranged on the membrane; (iii) depositing a second SiO₂ layer on the first layer on the side of the cavity, so as to increase the thickness of the membrane.

### CROSS-REFERENCE TO RELATED APPLICATION

This application claims priority to foreign French patent application No FR 2409785 filed on September 13 2024 the disclosure of which is incorporated by reference in its entirety

### FIELD OF APPLICATION

The invention relates to a photonic waveguide device mounted on a membrane suspended above a semiconductor substrate, and to a process for fabricating same.

### BACKGROUND

Many fabrication techniques have been developed with a view to producing microstructures and nanostructures on semiconductor substrates in order to fabricate integrated circuits and systems. These systems cover a multitude of uses, such as transistor-based microelectronic circuits, microsystems such as MEMS (acronym for microelectromechanical systems) or NEMS (acronym for nanoelectromechanical systems), integrated sensors (pressure sensors, accelerometers, chemical sensors, etc.) or photonic and optoelectronic systems integrated on a semiconductor substrate.

More specifically, it is possible to produce photonic circuits, with laser emitters associated with layers for processing the emitted beams (guidance, multiplexing/demultiplexing, amplification, etc.), the one or more processing layers being deposited on a silicon substrate ("photonic on silicon"). The emitting lasers may be integrated into the chip of the photonic circuit or be external to the chip of the photonic circuit.

By way of illustrative and non-limiting example, FIG. 1 illustrates a perspective view of a photonic device according to the prior art. The coupler D0 comprises an optical guide structure WG0 that is made of a first dielectric material and arranged on an SiO₂ layer C0 that is arranged on a bulk silicon substrate. The layers are stacked in a direction Z normal to a plane (X,Y). The optical guide structure WG0 extends along a direction Y orthogonal to the stacking direction Z. The optical guide structure WG0 is intended to confine an electromagnetic wave that is propagated along its direction of extension Y.

Many problems have been clearly identified in photonic circuits according to the prior art. Indeed, in some parts of the circuit, such as input couplers or RF modulators, the propagated light beam widens and confinement is not ideal, especially in transitions from one part of the photonic circuit to another. Light has a tendency to go towards the material with the highest optical index. In solutions from the prior art, the SiO₂ layer separating the guide structure from the substrate has a thickness generally less than 1 µm, and at best between 2 and 3 µm. This results in an overlap between light and the semiconductor substrate located below the guide structure. This overlap leads to optical leakage, and therefore losses. These losses lead to a decrease in the output power obtained for conventional photonic circuits and, in the context of quantum photonics, to considerable deterioration of the signal, rendering it useless for performing quantum operations. In this context, eliminating coupling of the propagated wave with the semiconductor substrate becomes crucial.

In the context of the invention, "thermal SiO₂" is understood to mean a silicon dioxide layer formed by way of thermal oxidation of silicon wafers. This process consists in heating the silicon wafers in an oxygen-rich environment, thereby resulting in the formation of a thin surface layer of SiO₂. Thermal SiO₂ is commonly used in the fabrication of semiconductor components for its excellent electrical insulation properties.

In the context of the invention, "non-thermal SiO₂" or "deposited SiO₂" is understood to mean a layer of silicon dioxide formed by way of deposition techniques such as plasma-enhanced chemical vapour deposition, sputtering or other deposition methods. This terminology is commonly used to distinguish SiO₂ layers formed by way of deposition processes from those formed by way of thermal oxidation of silicon.

From a structural point of view, it is possible to distinguish a thermal SiO₂ layer from a non-thermal SiO₂ layer via the following parameters:

material density: thermal SiO₂ has a density greater than that of deposited SiO₂. This is reflected in that silicon and oxygen atoms are generally more closely bonded and more densely stacked due to the oxidation process of crystalline silicon that occurs during thermal formation. presence of free hydrogen bonds: thermal SiO₂ does not have free hydrogen bonds, which is not the case in deposited SiO₂. density: thermal SiO₂ has a density greater than that of non-thermal SiO₂.

Analytical techniques such as X-ray reflection, Raman spectroscopy, Fourier transform infrared (FTIR) spectroscopy, ellipsometry and electron microscopy may be used to characterize the structure and composition of SiO₂ films, and thus differentiate between a thermal SiO₂ layer and a non-thermal deposited SiO₂ layer.

### Prior art/Restrictions of the prior art

Among the solutions envisaged in the prior art, it is possible to observe the increase in distance separating the optical guide structure from the semiconductor substrate due to the increase in the thickness of the thermal SiO₂ layer. However, current fabrication methods lack reproducibility, produce fragile structures or are expensive, making them difficult to apply in industry. Indeed, increasing the thickness of said layer to thicknesses sufficient to eliminate coupling requires a thermal oxidation time of the order of a few days, which is highly expensive in terms of time and energy. As an alternative, in the case of using SoI (acronym for silicon on insulator) wafers, the thickness of the SiO₂ layer is predetermined by the supplier.

In addition, obtaining a thermal SiO₂ layer having a thickness greater than 5 µm requires multiple thermal annealing cycles carried out at temperatures greater than 800°C. This leads to an increase in the internal mechanical tensions within the layers forming the photonic circuit, making it weaker.

As an alternative, the deposition of an additional layer of non-thermal SiO₂ on the thermal SiO₂ layer degrades the interface seen by the optical guide structure due to the presence of free hydrogen bonds. These bonds absorb part of the propagated electromagnetic wave for targeted wavelengths, and thus reduce the performance of the photonic circuit.

### Response to the problem and provision of a solution

In order to overcome the limitations of the existing solutions with regard to implementation, the invention proposes a fabrication process for obtaining an optical guide structure that is based on a membrane formed by a stack comprising at least one thermal SiO₂ layer and one non-thermal SiO₂ layer. The membrane makes it possible to separate the guide structure from the semiconductor substrate, and thus to eliminate optical losses due to the overlap of the propagated wave with the semiconductor.

Moreover, the process according to the invention makes it possible to produce a membrane having a thickness sufficient to improve confinement in the guide structure without having to resort to a plurality of thermal annealing operations. This makes it possible to avoid the drawbacks of the thermal annealing operations described above, namely the thermal budget and the introduction of mechanical fragility.

Moreover, the process according to the invention makes it possible to keep an interface between the guide structure and the thermal SiO₂, and thus not to degrade the optical performance of the photonic circuit through absorption.

One subject of the invention is a process for fabricating a photonic device, comprising the following steps:

A guide structure with a reduction in optical losses is then obtained by virtue of the process according to the invention, without degrading the mechanical robustness of the device or the propagated optical power.

### SUMMARY OF THE INVENTION

providing an optical guide structure arranged on a first thermal SiO₂ layer; the first layer being arranged on a first face of a substrate made of a semiconductor material;

etching the second face, opposite the first face, of the substrate below at least part of the optical guide structure to the first thermal SiO₂ layer so as to obtain a membrane formed by part of the first layer that is suspended above a cavity delimited by two pillars; the optical guide structure being arranged on said membrane; depositing a second SiO₂ layer on the first layer on the side of the cavity, so as to increase the thickness of the membrane.

According to one particular aspect of the invention, step (iii) of depositing the second layer is carried out by way of high-density plasma chemical vapour deposition or by way of atomic layer deposition or by way of pulsed laser deposition or by way of low-pressure chemical vapour deposition.

According to one particular aspect of the invention, step (i) comprises a subprocess for fabricating the optical guide structure on the first thermal SiO₂ layer.

According to one particular aspect of the invention, the subprocess for fabricating the optical guide structure (WG) comprises the following substeps:

providing a substrate (SOI) comprising a silicon film positioned on a buried thermal SiO₂ layer positioned on a bulk silicon carrier; etching the substrate so as to produce a strip forming an optical guide structure from the silicon film on the buried thermal SiO₂ layer.

According to one particular aspect of the invention, the subprocess for fabricating the optical guide structure comprises the following substeps:

providing the bulk substrate made of a semiconductor material; depositing the first thermal SiO₂ layer on the substrate by way of thermal oxidation; depositing an intermediate layer made of a dielectric material on the first layer; etching the intermediate layer so as to structure the optical guide structure.

According to one particular aspect of the invention, the process furthermore comprises the following step: depositing a third SiO₂ layer on the second layer on the side of the cavity; step (iv) being carried out by way of plasma-enhanced chemical vapour deposition or by way of sputtering or by way of spin coating.

According to one particular aspect of the invention, the process furthermore comprises the following step: polishing the two pillars on the side of the cavity, so as to expose at least part of the substrate made of a semiconductor material.

According to one particular aspect of the invention, the process furthermore comprises the following step: encapsulating at least part of the guide structure in a dielectric encapsulating layer.

According to one particular aspect of the invention, the process furthermore comprises the following step: filling the cavity with an adhesive liquid having an optical index within the range [nₒₚₜ -10%, nₒₚₜ+10%], nₒₚₜ being the refractive index of the membrane.

The invention also relates to a photonic device comprising an optical guide structure arranged on a membrane suspended between two pillars; said membrane being formed by a stack of layers comprising a first thermal SiO₂ layer and at least one second non-thermal SiO₂ layer; the first layer being confined between the optical guide structure and the second layer.

According to one particular aspect of the invention, the membrane has a thickness greater than 3 µm.

According to one particular aspect of the invention, the first layer has a density greater than that of the second layer.

### BRIEF DESCRIPTION OF THE DRAWINGS

Other features and advantages of the present invention will become more clearly apparent on reading the following description with reference to the following appended drawings.

FIG. 1 illustrates a perspective view of a photonic device according to the prior art. This figure has already been described.

FIG. 2 illustrates the flowchart of a fabrication process according to the invention.

FIG. 3a illustrates the structure obtained at the end of the first step of the fabrication process according to the invention.

FIG. 3b illustrates the structure obtained at the end of the second step of the fabrication process according to the invention.

FIG. 3c illustrates the structure obtained at the end of the third step of the fabrication process according to the invention.

FIG. 3d illustrates the structure obtained at the end of the fourth step of the fabrication process according to the invention.

FIG. 3e illustrates the structure obtained at the end of the fifth step of the fabrication process according to the invention.

FIG. 4 illustrates a photonic device according to the invention.

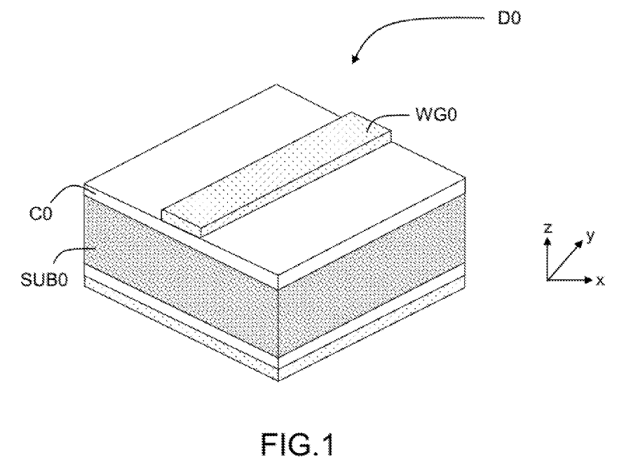

### DETAILED DESCRIPTION

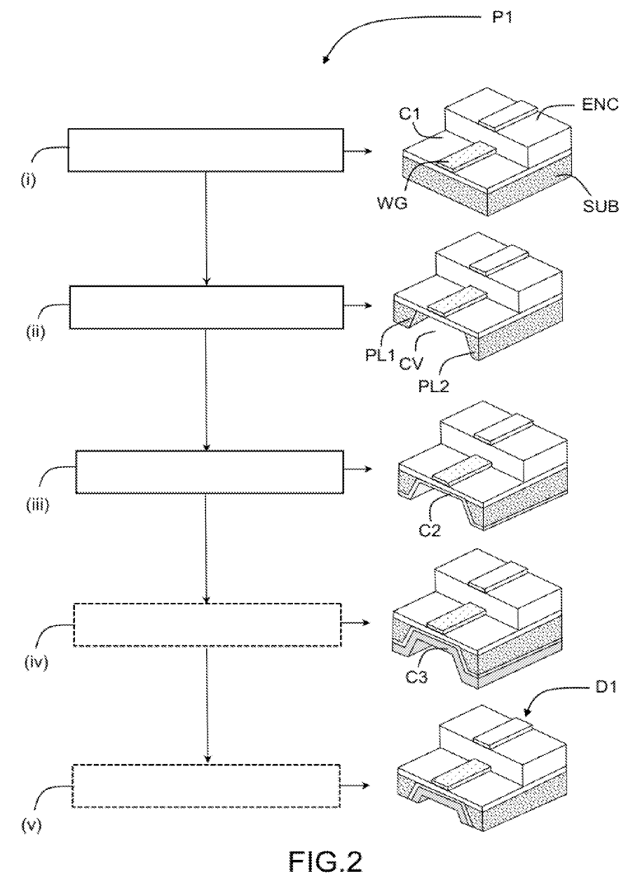

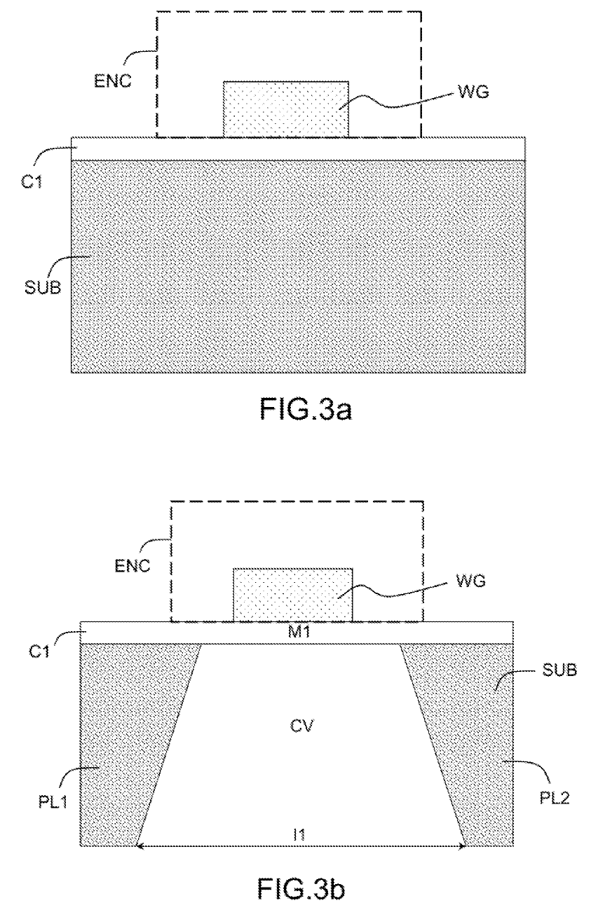

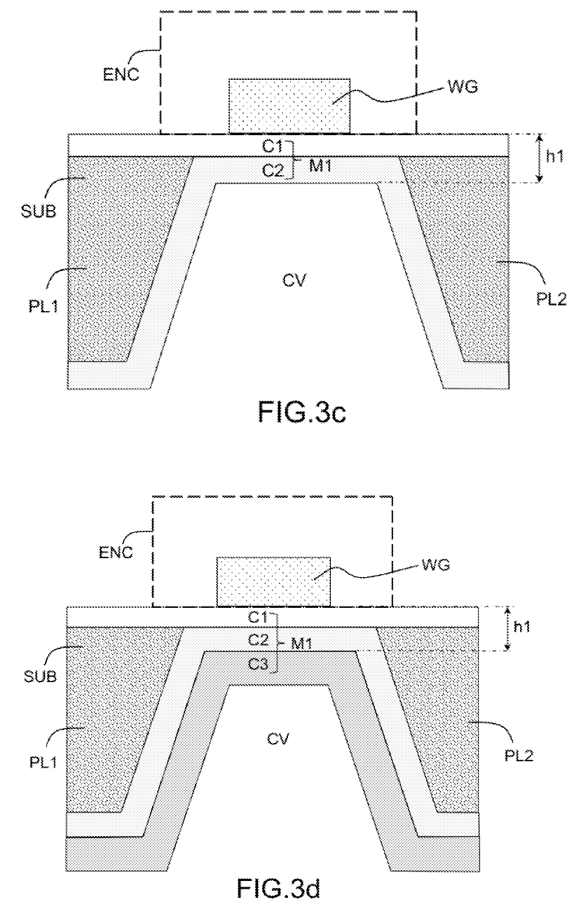

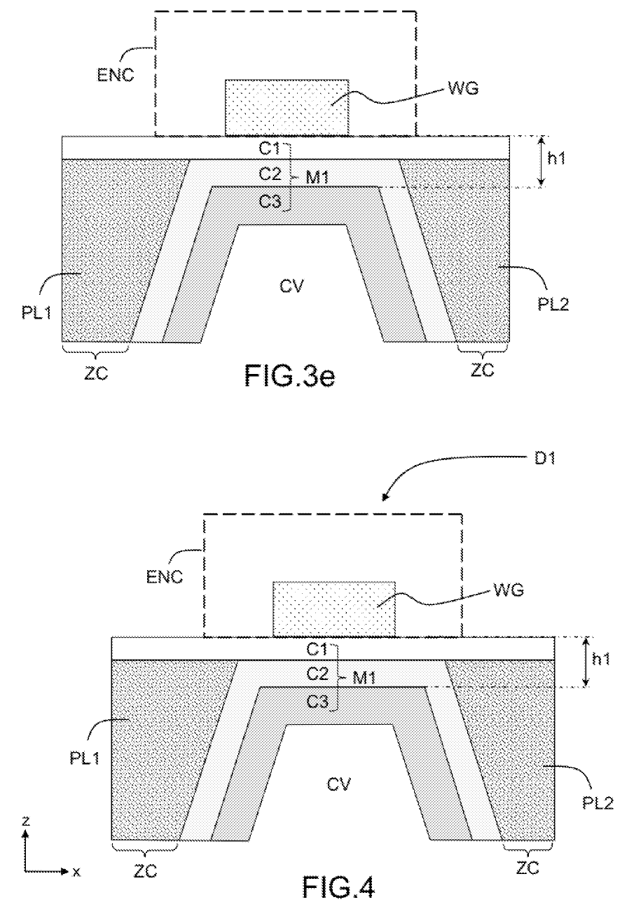

FIG. 2 illustrates the flowchart of the process P1 for fabricating a photonic device D1 according to the invention. FIGS. 3a to 3e illustrate the steps of the process P1 according to the invention.

The first step (i) consists in providing an optical guide structure WG arranged on a first thermal SiO₂ layer C1. The intermediate structure obtained at the end of the first step (i) is illustrated in FIG. 3a. The first layer C1 is arranged on an upper first face of a substrate SUB made of a semiconductor material, more particularly of silicon. The optical guide structure WG extends along a direction Y orthogonal to the stacking direction Z. The optical guide structure WG is intended to confine an electromagnetic wave that is propagated along its direction of extension Y. The first layer C1 is obtained by way of thermal oxidation of the silicon substrate. The first layer C1 has a thickness of between 2 µm and 3 µm. The substrate SUB has a thickness greater than 100 µm. The guide structure is a strip made of a dielectric or semiconductor material having an optical index at least 20% higher than the optical index of SiO₂, for example silicon or silicon nitride SiN. Advantageously, the stack provided in step (i) furthermore comprises an SiO₂ encapsulating layer ENC in which at least part of the guide structure is buried. The encapsulating layer ENC makes it possible to protect the guide structure WG when it is flipped in subsequent steps of the fabrication process P1.

The first step (i) may be limited to providing the prefabricated structure described in FIG. 3a. As an alternative, the first step (i) comprises a subprocess for fabricating the optical guide structure WG on the first thermal SiO₂ layer C1. The subprocess for fabricating the optical guide structure WG depends on the use of a bulk silicon substrate SUB or of an SoI (acronym for silicon on insulator) substrate SUB.

According to a first variant, the subprocess for fabricating the guide structure comprises the following substeps: providing the bulk silicon substrate SUB, then forming the first thermal SiO₂ layer C1 on the substrate by way of thermal oxidation; then depositing an intermediate layer made of a dielectric or semiconductor material, for example SiN, on the first layer C1, and finally etching the intermediate layer so as to obtain the strip forming the optical guide structure WG.

By way of example, the SiN intermediate layer is deposited by way of low-pressure chemical vapour deposition (LPCVD).

According to a second variant, the subprocess for fabricating the guide structure comprises the following substeps: providing an SoI substrate comprising a silicon film positioned on a buried thermal SiO₂ layer positioned on a bulk silicon substrate SUB; then etching the silicon film so as to obtain the strip forming the optical guide structure WG and to expose the buried thermal SiO₂ layer around the optical guide structure WG.

Optionally, the process P1 comprises a step of encapsulating the optical guide structure WG by depositing a dielectric encapsulating layer ENC, for example made of SiO₂. By way of example, the encapsulating layer ENC is deposited by way of high-density plasma chemical vapour deposition (HDPCVD) or by way of atomic layer deposition (ALD) or by way of pulsed laser deposition (PLD) or by way of low-pressure chemical vapour deposition (LPCVD). All of these techniques exhibit a good compromise between quality of the material obtained, on the one hand, and ease of integration and installation in the context of a microengineering fabrication process, on the other hand. Physical protection of the guide structure is thus achieved, without degrading the optical performance of the device.

The second step (ii) consists in etching the lower second face, opposite the first face, of the substrate SUB. The intermediate structure obtained at the end of the second step (ii) is illustrated in FIG. 3b. The structure provided in step (i) is flipped in order to carry out back etching. The second face, opposite the first face, of the substrate is etched below at least part of the optical guide structure WG to the first thermal SiO₂ layer C1. The back etching makes it possible to form a membrane that is formed by part of the first layer C1 that is suspended above a cavity CV delimited by two pillars PL1, PL2. The optical guide structure WG is arranged on this membrane M1. The membrane M1 in the present state has a thickness of between 2 µm and 3 µm. The membrane is made of thermal SiO₂ with a maximized density, absence of free hydrogen bonds and a regular interface (without roughness defects). The volume of semiconductor material of the substrate SUB that was previously located below the guide structure is eliminated. The cavity CV has a width l1 greater than the width of the guide structure WG. The width l1 of the cavity CV is between 10 µm and 200 µm. The back etching is carried out by way of a dry and/or wet etching technique. The partial elimination of the substrate below the guide structure WG makes it possible to eliminate optical losses resulting from the overlap between light and the semiconductor substrate.

The third step (iii) consists in depositing a second SiO₂ layer C2 on the first layer C1 on the side of the cavity CV, so as to increase the thickness of the membrane M1. The intermediate structure obtained at the end of the third step (iii) is illustrated in FIG. 3c. The second layer is deposited by way of high-density plasma chemical vapour deposition (HDPCVD) or by way of atomic layer deposition (ALD) or by way of pulsed laser deposition (PLD) or by way of low-pressure chemical vapour deposition (LPCVD). The second layer C2 has a quality that is worse than the first thermal SiO₂ layer but sufficient to achieve better optical performance with reduced losses compared to known solutions. On the other hand, the implementation of this step is simpler and less energy-consuming than thermal oxidation. The techniques listed above make it possible to achieve a compromise between quality of the material obtained, on the one hand, and ease of integration and installation in the context of a microengineering fabrication process, on the other hand. The addition of the lower second layer C2 makes it possible to increase the thickness h1 of the membrane M1 to values greater than 3 µm without having to resort to thermal annealing operations. The increase in thickness of the membrane M1 makes it possible, at the same time, to eliminate optical losses caused by overlapping and to mechanically reinforce the fabricated photonic device. Moreover, the membrane M1 makes it possible to keep a contact interface between the guide structure WG and the first thermal SiO₂ layer C1. It will be recalled that thermal SiO₂ exhibits better density and an absence of free hydrogen bonds, and therefore minimizes losses caused by absorption of propagated light.

The fourth step (iv) consists in depositing a third SiO₂ layer C3 on the second layer C2 on the side of the cavity CV. The intermediate structure obtained at the end of the fourth step (iv) is illustrated in FIG. 3d. Step (iv) is carried out by way of plasma-enhanced chemical vapour deposition (PECVD) or by way of sputtering or by way of spin coating. The third layer C3 makes it possible to mechanically reinforce the structure, and more particularly the membrane. The deposition techniques that are used make it possible to obtain a reinforcing layer C3 quickly and inexpensively. The optical quality of the SiO₂ of the third layer C3 is worse than that of the first layer C1 or the second layer C2, but this does not degrade the confinement of propagated light. This is because the third layer C3 is far enough away from the guide structure WG. The distance between the third layer C3 and the guide structure WG is greater than 3 µm.

Advantageously, and optionally, the process P1 comprises a step (v) of polishing the two pillars PL1, PL2 on the side of the cavity CV. This makes it possible to remove the SiO₂ deposited on the lower surface of the pillars PL1, PL2 and to expose at least part of the substrate SUB made of a semiconductor material. This makes it possible to create zones of electrostatic contact ZC between the substrate SUB and the fabrication machines. The zones of electrostatic contact make it possible to prevent the accumulation of electric charge at the interface between the substrate SUB and the fabrication machines in the various steps of the chip fabrication process. The intermediate structure obtained at the end of the polishing step is illustrated in FIG. 3d.

Advantageously, and optionally, the process P1 comprises a step of filling the cavity CV with an adhesive liquid having an optical index within the range [nₒₚₜ -10%, nₒₚₜ+10%], nₒₚₜ being the refractive index of the membrane M1. This makes it possible to improve the confinement of propagated light in the guide structure WG.

FIG. 4 illustrates the photonic device D1 according to the invention. The photonic device D1 comprises an optical guide structure WG placed on a membrane M1 that is suspended between two pillars PL1, PL2. This membrane M1 is formed by a stack of layers, comprising a first thermal SiO₂ layer C1 and at least one second non-thermal or deposited SiO₂ layer C2. The first layer C1 is confined between the optical guide structure WG and the second layer C2. The membrane M1 has a thickness greater than 3 µm. This suspended structure makes it possible to eliminate optical losses caused by overlapping with the substrate and enables improved mechanical robustness. The first thermal SiO₂ layer C1 makes it possible to achieve a regular and dense interface with the guide structure, and thus improve the optical performance of the system. The first thermal SiO₂ layer C1 does not have free hydrogen bonds, thereby making it possible to limit losses caused by absorption of light propagated by the membrane M1. Optionally, the membrane M1 comprises a third non-thermal SiO₂ layer C3 for mechanically reinforcing the floating structure. Optionally, the guide structure WG is encapsulated in a dielectric encapsulating layer in order to protect it mechanically.

The photonic device D1 may be a directional coupler or a radiofrequency modulator or a ring source. A photonic directional coupler is an optical device that makes it possible to split or combine light coming from various optical channels in a controlled manner. A photonic RF (radiofrequency) modulator is an optoelectronic device used to modulate an optical signal in response to a radiofrequency (RF) electrical signal. It makes it possible to control various characteristics of light, such as its amplitude, frequency or phase. A photonic ring source is an optical device that uses a ring-shaped structure to generate photons. Light injected into the ring undergoes multiple internal reflections, thereby possibly increasing photon generation efficiency at certain wavelengths. These sources are used in various photonics applications for their ability to produce high-quality light and precisely control the emitted wavelength.

1. A process (P1) for fabricating a photonic device (D1), comprising the following steps:
(i) providing an optical guide structure (WG) arranged on a first thermal SiO₂ layer; the first layer (C1) being arranged on a first face of a substrate (SUB) made of a semiconductor material;
(ii) etching the second face, opposite the first face, of the substrate (SUB) below at least part of the optical guide structure (WG) to the first thermal SiO₂ layer (C1) so as to obtain a membrane (M1) formed by part of the first layer that is suspended above a cavity (CV) delimited by two pillars (PL1, PL2); the optical guide structure (WG) being arranged on said membrane (M1);
(iii) depositing a second non-thermal SiO₂ layer (C2) on the first layer (C1) on the side of the cavity (CV), so as to increase the thickness of the membrane (M1).

2. The process (P1) for fabricating a photonic device (D1) according to claim 1, wherein step (iii) of depositing the second layer (C2) is carried out by way of high-density plasma chemical vapour deposition (HDPCVD) or by way of atomic layer deposition (ALD) or by way of pulsed laser deposition (PLD) or by way of low-pressure chemical vapour deposition (LPCVD).

3. The process (P1) for fabricating a photonic device (D1) according to claim 1, wherein step (i) comprises a subprocess for fabricating the optical guide structure (WG) on the first thermal SiO₂ layer (C1).

4. The process (P1) for fabricating a photonic device (D1) according to claim 3, wherein the subprocess for fabricating the optical guide structure (WG) comprises the following substeps:
providing a substrate (SOI) comprising a silicon film positioned on a buried thermal SiO₂ layer positioned on a bulk silicon carrier;
etching the substrate so as to produce a strip forming an optical guide structure from the silicon film on the buried thermal SiO₂ layer.

5. The process (P1) for fabricating a photonic device (D1) according to claim 3, wherein the subprocess for fabricating the optical guide structure (WG) comprises the following substeps:
providing the bulk substrate (SUB) made of a semiconductor material;
depositing the first thermal SiO₂ layer (C1) on the substrate by way of thermal oxidation;
depositing an intermediate layer made of a dielectric material on the first layer (C1);
etching the intermediate layer so as to structure the optical guide structure (WG).

6. The process (P1) for fabricating a photonic device (D1) according to claim 1, furthermore comprising the following step:
(iv) depositing a third SiO₂ layer (C3) on the second layer (C2) on the side of the cavity (CV); step (iv) being carried out by way of plasma-enhanced chemical vapour deposition (PECVD) or by way of sputtering or by way of spin coating.

7. The process (P1) for fabricating a photonic device (D1) according to claim 1, furthermore comprising the following step:
(v) polishing the two pillars (PL1, PL2) on the side of the cavity (CV), so as to expose at least part of the substrate (SUB) made of a semiconductor material.

8. The process (P1) for fabricating a photonic device (D1) according to claim 1, furthermore comprising the following step:
encapsulating at least part of the guide structure (WG) in a dielectric encapsulating layer (ENC).

9. The process (P1) for fabricating a photonic device (D1) according to claim 1, furthermore comprising the following step:
filling the cavity (CV) with an adhesive liquid having an optical index within the range [nₒₚₜ -10%, nₒₚₜ+10%], nₒₚₜ being the refractive index of the membrane (M1).

10. A photonic device (D1) comprising an optical guide structure (WG) arranged on a membrane (M1) suspended between two pillars (PL1, PL2); said membrane (M1) being formed by a stack of layers comprising a first thermal SiO₂ layer (C1) and at least one second non-thermal SiO₂ layer (C2); the first layer (C1) being confined between the optical guide structure (WG) and the second layer (C2).

11. The photonic device (D1) according to claim 10, wherein the membrane has a thickness greater than 3 µm.

12. The photonic device (D1) according to claim 10, wherein the first layer (C1) has no free hydrogen bonds.

13. The photonic device (D1) according to claim 10, wherein the first layer (C1) has a density greater than that of the second layer (C2).
